(19) United States
(12) Patent Application Publication
(10) Pub. No.: US 2004/0221738 A1
(43) Pub. Date: Nov. 11, 2004

(54) Bread maker and control method thereof

(75) Inventors: Jae-Ryong Park, Suwon-city (KR); Yong-Hyun Kwon, Suwon-city (KR); Chul Kim, Anyang-city (KR); Tae-Uk Lee, Suwon-city (KR); Han-Jun Sung, Suwon-city (KR); Jang-Woo Lee, Suwon-city (KR); Dong-Bin Lim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/805,406

(22) Filed: Mar. 22, 2004

(30) Foreign Application Priority Data
May 7, 2003 (KR) 2003-29069

(51) Int. Cl. A23L 1/00

(52) U.S. Cl. 99/348

(57) ABSTRACT

A bread maker and a control method thereof to perform a plurality of bread making processes in respective processing temperatures during predetermined processing times, includes a plurality of heaters heating ingredients to make bread in different directions from each other; a heater driving part supplying a driving power to each heater and controlling a heating power of each heater; a temperature sensor detecting temperature of an oven compartment; a process condition storing part storing a process condition data including the processing times and the processing temperatures of the plurality of bread making processes; and a controller controlling the heater driving part to maintain temperature of the oven compartment in the processing temperature by controlling the heating power of each heater according to a temperature sensed by the temperature sensor and the process condition data of the process condition storing part. Thus, temperature of the oven compartment is maintained in a processing temperature and heating powers of a plurality of heaters are adjusted, so that temperature is accurately controlled and an optimum product is obtained.

### CROSS-REFERENCE TO RELATED APPLICATIONS

This application claims the benefit of Korean Application No. 2003-29069, filed May 7, 2003, in the Korean Intellectual Property Office, the disclosure of which is incorporated herein by reference.

### BACKGROUND OF THE INVENTION

1. Field of the Invention

The present invention relates to a bread maker and a control method thereof, and more particularly to a bread maker and a control method thereof performing a plurality of bread making processes at respectively different temperatures during respectively predetermined processing times.

2. Description of the Related Art

Generally, once a user puts ingredients to make bread in the bread maker, a bread maker provides fresh bread to the user by automatically performing kneading, leavening, and baking of bread dough. For example, a bread maker disclosed in Korean Patent First Publication No. 1988-7000638 includes a pair of parallel kneading drums at upper and lower parts of an oven compartment that reverse rotary direction periodically, a baking tray between the pair of kneading drums, a heater heating the inside of the oven compartment, a bar code reader, etc.

The bread maker winds opposite ends of a mixing bag filled with the ingredients, such as dough and water, on the kneading drums, and kneads the ingredients in the mixing bag by moving the mixing bag up and down during a predetermined time period.

When the kneading process is completed, a cutting unit cuts the mixing bag, so that only kneaded ingredients are left in the baking tray. The kneaded ingredients are leavened and baked by heat generated from the heater, so that bread is made in the baking tray.

A series of bread making processes are performed as follows. A bar code scanner reads a bar code, which includes information of a bread making program, such as a kneading time, a leavening time and a baking time and is attached on the mixing bag and transmits the read information of the bread making program to a controller. The controller controls operation of components of the bread maker, such as the kneading drums and the heater, according to the read information of the bar code.

According to a conventional bread maker described above, only one heater is provided, and there is a difficulty in making an optimum product by turning the single heater on and off accordingly.

### SUMMARY OF THE INVENTION

It is an aspect of the present invention to provide a bread maker and a control method thereof to accurately control temperature and obtain an optimum product by maintaining temperature of the oven compartment at a predetermined processing temperature by adjusting heating powers of a plurality of heaters.

According to the present invention, a bread maker performing a plurality of bread making processes in respective processing temperatures during predetermined processing times, comprises: a plurality of heaters heating ingredients to make bread in different directions from each other; a heater driving part supplying a driving power to each heater and controlling a heating power of each heater; a temperature sensor detecting temperature of an oven compartment; a process condition storing part storing process condition data including the processing times and the processing temperatures of the plurality of bread making processes; and a controller controlling the heater driving part to maintain the temperature of the oven compartment at the processing temperature by controlling the heating power of each heater according to a temperature sensed by the temperature sensor and the process condition data of the process condition storing part.

In an aspect of the invention, the plurality of heaters comprises an upper oven heater and an upper door heater which are provided in upper parts of an inside wall of the oven compartment and a door to open and close a front opening of the oven compartment to heat front and back areas of an upper part of a baking tray accommodating ingredients to make bread, and a lower oven heater and a lower door heater which are provided in lower parts of the inside walls of the oven compartment and the door to heat front and back areas of an lower part of the baking tray.

In an aspect of the invention, the controller controls the heater driving part to turn the upper oven heater, the upper door heater, the lower oven heater, and the lower door heater off during a kneading process.

In an aspect of the invention, the controller controls the heater driving part to decrease the heating powers of the upper oven heater and the upper door heater and to relatively increase the heating powers of the lower oven heater and the lower door heater according to the heating powers of the upper oven heater and the upper door heater during a leavening process.

In an aspect of the invention, the controller controls the heater driving part so that the heating powers of the upper oven heater and the upper door heater are turned off and duties of the lower oven heater and the lower door heater are 10 through 40% during the leavening process.

In an aspect of the invention, the controller controls the heater driving part to increase the heating powers of the upper oven heater and the upper door heater and to relatively decrease the heating powers of the lower oven heater and the lower door heater according to the heating powers of the upper oven heater and the upper door heater during a baking process.

In an aspect of the invention, the controller controls the heater driving part so that duties of the heating powers of the upper oven heater and the upper door heater are 80 through 100% and duties of the lower oven heater and the lower door heater are 70 through 90% during the baking process.

According to the present invention, there is provided a control method of a bread maker performing a plurality of bread making processes in different processing temperatures from each other during predetermined processing times; providing a plurality of heaters heating ingredients to make bread in different directions; previously storing process condition data including the processing times and the processing temperatures of the plurality of bread making processes; sensing temperature of an oven compartment; controlling a heater driving part to maintain temperature of the oven compartment in the processing temperature by controlling the heating power of each heater according to the sensed temperature and the previously stored process condition data.

In an aspect of the invention, the plurality of heaters comprises an upper oven heater and an upper door heater which are provided in upper parts of an inside wall of the oven compartment and a door to open and close a front opening of the oven compartment to heat front and back areas of an upper part of a baking tray accommodating ingredients to make bread, and a lower oven heater and an lower door heater which are provided in lower parts of the inside walls of the oven compartment and the door to heat front and back areas of an lower part of the baking tray.

In an aspect of the invention, the method of controlling of the heater driving part comprises controlling the heater driving part to turn the upper oven heater, the upper door heater, the lower oven heater, and the lower door heater off during a kneading process.

In an aspect of the invention, the method of controlling of the heater driving part comprises controlling the heater driving part to decrease the heating powers of the upper oven heater and the upper door heater and to relatively increase the heating powers of the lower oven heater and the lower door heater according to the heating powers of the upper oven heater and the upper door heater during a leavening process.

In an aspect of the invention, the controlling of the heater driving part during the leavening process comprises controlling the heater driving part so that the heating powers of the upper oven heater and the upper door heater are turned off and duties of the lower oven heater and the lower door heater are 10 through 40%.

In an aspect of the invention, the controlling of the heater driving part comprises controlling the heater driving part to increase the heating powers of the upper oven heater and the upper door heater and to relatively decrease the heating powers of the lower oven heater and the lower door heater according to the heating powers of the upper oven heater and the upper door heater during a baking process.

In an aspect of the invention, the controlling of the heater driving part during the baking process comprises controlling the heater driving part so that duties of the heating powers of the upper oven heater and the upper door heater are 80 through 100% and duties of the lower oven heater and the lower door heater are 70 through 90%.

Additional and/or other aspects and advantages of the invention will be set forth in part in the description that follows, and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompany drawings of which:

FIG. 1 is a perspective view of a bread maker according to an embodiment of the present invention;

FIG. 2 is a sectional view illustrating a state that a bar code on a mixing bag is read, taken along a line II-II in FIG. 1;

FIG. 3 is a control block of the bread maker according to the present invention;

FIGS. 4 and 5 are exemplary views illustrating duty adjustment of heaters in respective processes.

FIG. 6 is a control flowchart of the bread maker according to the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

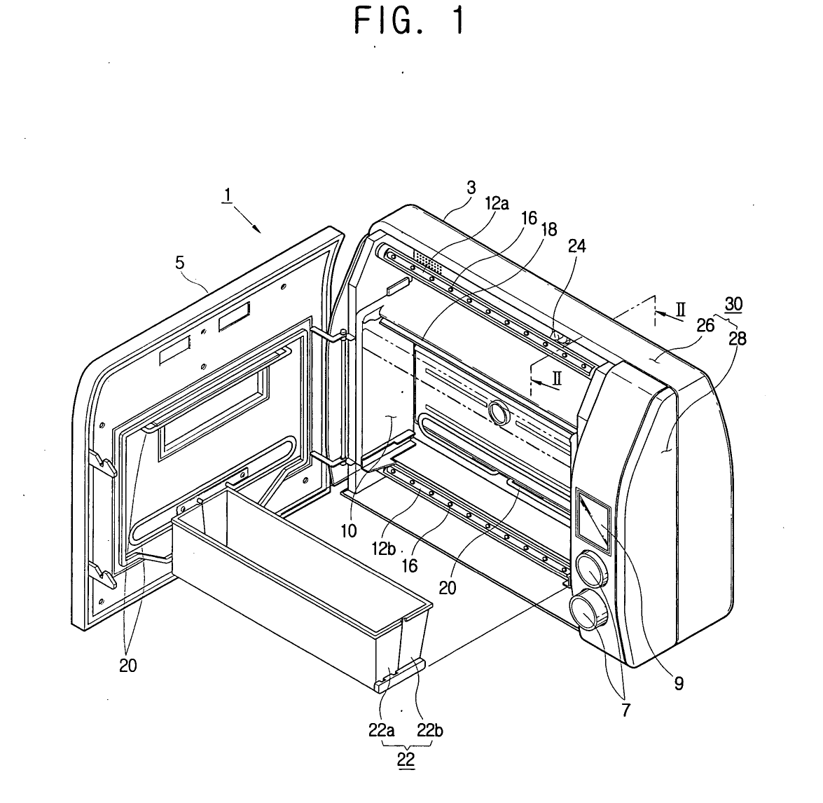

FIG. 1 is a perspective view of a bread maker according to an embodiment of the present invention. As shown in FIG. 1, the bread maker according to the embodiment of the present invention includes a main body 1 forming an oven compartment 10 having a box shape, a door 5 in the front of the main body 1 to open and close a front opening of the oven compartment 10, a control panel 7 in the front of the main body 1 to select an operation of the bread maker, and a displayer 9 to display data, such as operation states of the bread maker 1.

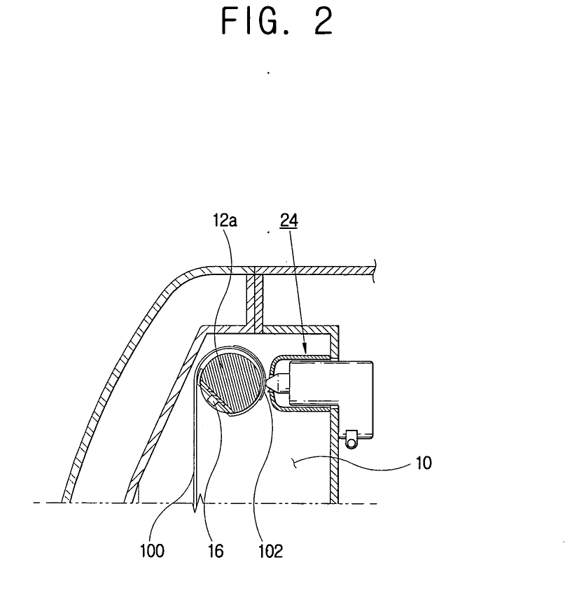

Inside the oven compartment 10, upper and lower kneading drums 12a and 12b are provided in parallel and reverse rotary direction periodically, onto which opposite ends of a mixing bag 100 (refer to FIG. 2) filled with raw materials (ingredients) to make bread are attached and wound. In a lower part of the oven compartment 10, a baking tray 22, which contains the dough for baking, is provided between the upper and lower kneading drums 12a and 12b.

The baking tray 22 includes first and second trays 22a and 22b having “L”-shaped cross sections symmetrical to one another. The first and second trays 22a and 22b combine to form a box having a top opening. In an upper part of the oven compartment 10, a pair of kneading members 18 provided between the upper kneading drum 12a and the baking tray 22 prevents the dough kneaded in the mixing bag 100 from moving beyond the baking tray 22 toward the upper kneading drum 12a. Holders 16 are provided in one side of the kneading drums 12a and 12b in a line along a lengthwise direction of the kneading drums 12a and 12b and have projection shapes. The holders 16 holds opposite ends of the mixing bag 100 filled with the ingredients and make the mixing bag 100 unmovable.

At upper parts of the inside walls of the oven compartment 10 and the door 5, an upper oven heater and an upper door heater to heat front and back areas of an upper part of the baking tray 22 are provided. At lower parts of the inside walls of the oven compartment 10 and the door 5, a lower oven heater and a lower door heater to heat front and back areas of a lower part of the baking tray 22 are provided.

A component compartment 30 includes a first component compartment 28 formed in one side of the oven compartment 10 and a second component compartment 26 formed in a rear of the oven compartment 10. Inside the first component compartment 28, a drum driving part (not shown) rotating the upper and lower kneading drums 12a and 12b in clockwise and counterclockwise directions is provided. Inside the second component compartment 26, a bar code reader 24 that reads a bar code 102 (refer to FIG. 2) printed on, or attached on, the mixing bag 100, which is wound on the upper and lower kneading drums 12a and 12b is provided. The bar code is registered with processing condition data of processing times and processing temperature, for example, a production date, a bread making program and ingredient information such as a kneading time, a leavening time and temperature, a baking time and temperature, vaporization, etc.

FIG. 2 is a sectional view illustrating a state that a bar code on a mixing bag is read, taken along a line II-II in FIG. 1. To input the bar code information to the bread maker 1, the kneading drums 12 are rotated by manipulation of the control panel 7 after the mixing bag 100 is attached to the holders 16 of the kneading drums 12. If one end of the mixing bag 100 is wound on the kneading drums 12 by the rotation of the kneading drums 12, the bar code 12 contacts a bar code sensor of the bar code reader 24 provided in a back of the kneading drums 12. The bar code reader 24 reads the bar code 102 attached on the mixing bag 100.

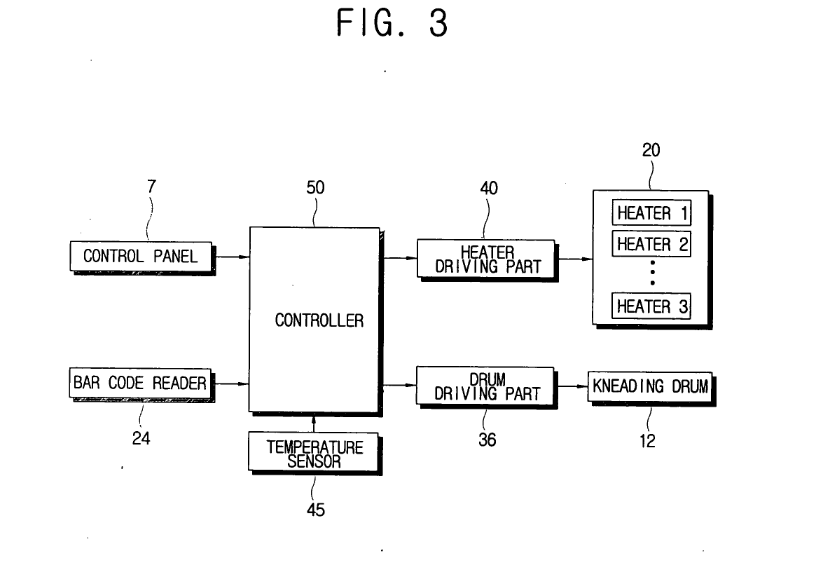

Also, the bread maker according to the present invention, as shown in FIG. 3, further comprises a temperature sensor 45 sensing a temperature of the oven compartment, and a controller 50 performs a control function.

The temperature sensor 45 is a sensor, such as a thermistor, and transmits a temperature sensing signal of the oven compartment 10 to the controller 50.

If a user selects a bar code input by using the control panel 7, the controller 50 controls the drum driving part 36 to supply a driving power to a driving motor of the kneading drums 12, and causes the mixing bag 100 attached on the kneading drums 12 to be wound by driving the kneading drums 12. As the mixing bag 100 is wound on the kneading drums 12, the bar code 102 on the mixing bag 100 is read through the bar code reader 24. The controller 50 kneads the ingredients filled in the mixing bag 100 by controlling the drum driving part 36 to drive the kneading drums 12 according to the bread making information of the kneading time, the leavening time and temperature, the baking time and temperature, vaporization, etc., which is inputted through the bar code reader 24. The controller 50 performs leavening and baking processes by supplying a driving power to a plurality of heaters 20 through a heater driving part 40 and controls the heating power of the plurality of heaters 20. Herein, the heating powers of the plurality of heaters 20 can be controlled by control of duties of the plurality of heaters 20.

The controller 50 is provided so that the temperature of the oven compartment, detected by the temperature sensor 45, is maintained in a setup temperature registered in the bar code 102, and respectively controls the duties of the respective plurality of heaters 20 provided in different positions by controlling on/off periods of switching devices (not shown) provided in the temperature sensor 45 and connected to the respective plurality of heaters 20.

When the controller 50 determines that the temperature sensed by the temperature sensor 45 reaches the setup temperature, the controller 50 controls the heater driving part 40 to end the heating of the plurality of heaters 20. Although the temperature of the oven compartment 10 reaches the setup temperature, the controller 50 continuously receives information of the temperature of the oven compartment 10 through the temperature sensor 45 during the bread making process because the temperature may vary during the process. That is, the controller 50 controls the temperature of the oven compartment 10 to maintain the setup temperature by feedback of the sensed temperature.

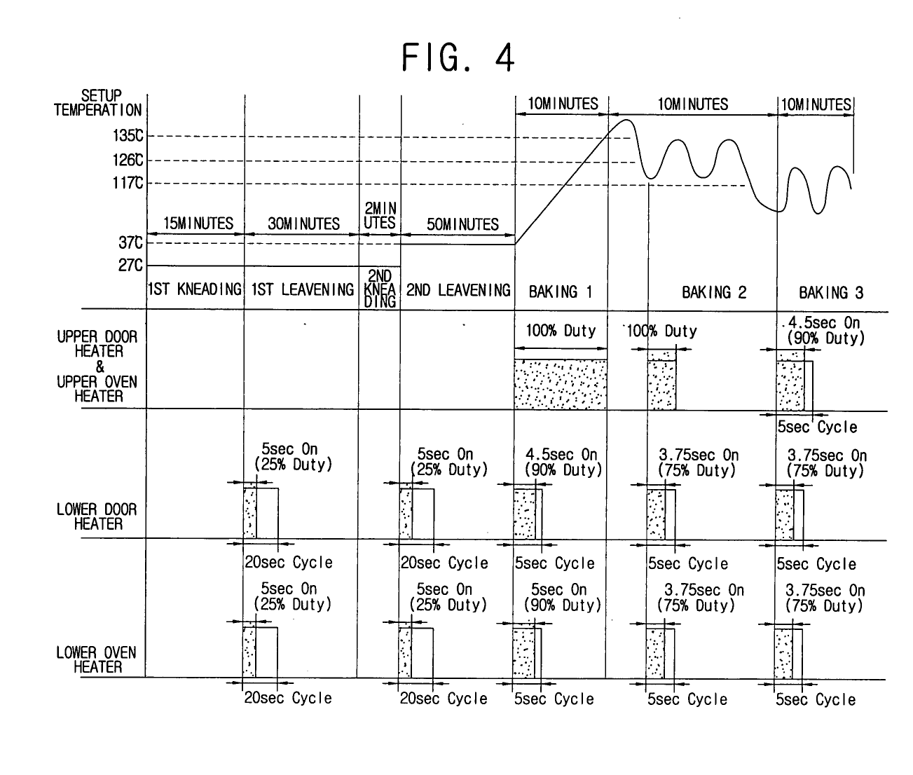

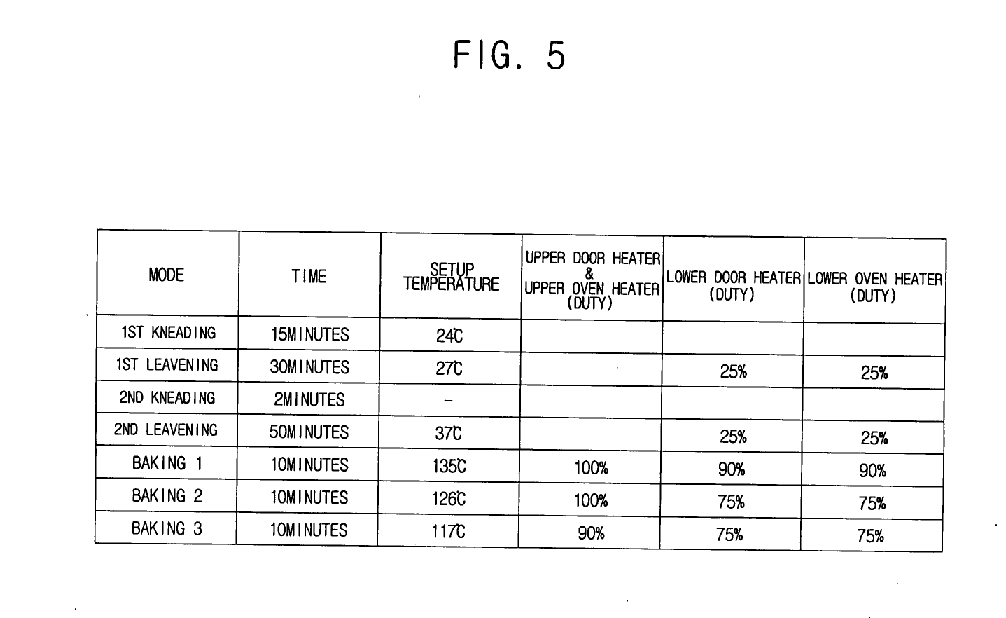

Duty control in each process is described as follows, with reference to FIGS. 4 and 5. As shown in FIGS. 4 and 5, since the kneading is conventionally performed within about 20 through 25° C., the heating of the plurality of heaters 20 is not required. Thus, the controller 50 determines that the sensed temperature of the oven compartment 10 is similar to the setup temperature in a kneading mode, and controls the heater driving part 40 to cause the plurality of heaters 20 to be turned off.

In a leavening mode, the temperature of the oven compartment reaches the setup temperature in the leavening mode by causing only the lower door heater and the lower oven heater to be heated at about a 25% duty. This is because the upper door heater and upper oven heater are positioned to directly heat the kneaded ingredients in the leavening, so that the kneaded ingredients can be burned.

The controller 50 operates all of the plurality of heaters 20 in a baking mode, and causes the temperature of the oven compartment 10 to reach the setup temperature in the baking mode by controlling the heater driving part 40 to adjust duties of the upper oven heater and the upper door heater to be higher than that of the lower oven heater and the lower door heater. That is, bread is baked in an optimum state by adjusting heating powers of the plurality of heaters 20 in different positions, for example, by applying relatively large heat to the upper part of the bread where the color of the bread is formed.

As described above, the duties of the plurality of heaters 20 in different positions are adjusted in each process, so that the temperature of the oven compartment 10 reaches the setup temperature registered in the bar code 102. The heating powers of the plurality of heaters 20 in different positions can be adjusted. Thus, an accurate temperature control is performed and the kneaded ingredients are heated in an optimum state in different positions.

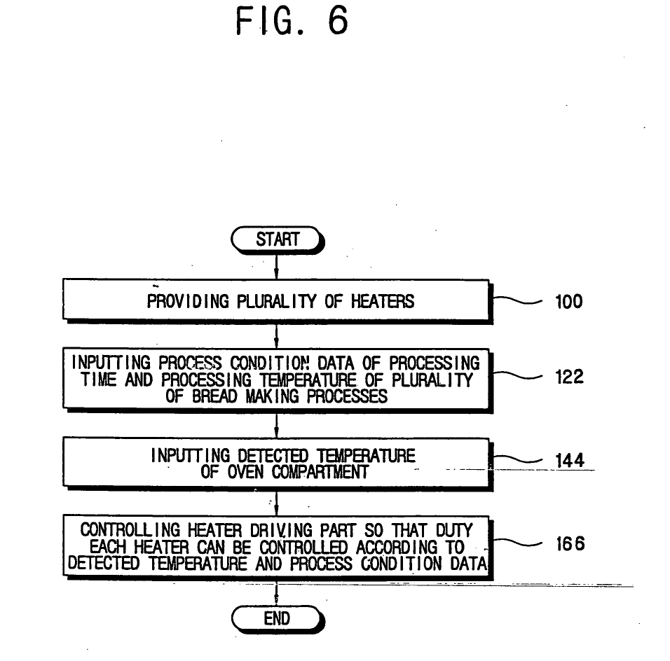

A flow diagram of the bread maker 1 with the above configuration is described as follows with reference to FIG. 6. As shown in FIG. 6, at first, the plurality of heaters 20 are provided in different positions from each other (100). The mixing bag 100, having the bar code 102 registered with data of the processing time and processing temperature of a plurality of bread making processes, is provided. When a user starts to make bread by using the bread maker 1, he/she inputs the data of the bar code 102 to the bread maker 1 by allowing the mixing bag 100 to be wound on the kneading drum 12. The controller 50 receives the data of the bar code 102 on the mixing bag 100 through the bar code reader 24 (122), and receives a temperature detected by the temperature sensor 45 (144).

The controller 50 compares the temperature detected by the temperature sensor 45 with the setup temperature of each process in the bar code data, and controls the heater driving part 40 so that the duties of the plurality of heaters 20 can be controlled (166). Thus, an optimum quality of bread can be obtained through an accurate temperature control.

In the above embodiment, the plurality of heaters 20 are provided in the upper and lower part of the inside wall of the oven compartment 10, and in the upper and lower part of the inside wall of the door 5, but the positions and numbers of the plurality of heaters 20 are not necessarily limited to that of the above embodiment.

In the above embodiment, all of the plurality of heaters 20 are turned off in the kneading process, but the plurality of heaters 20 may be operated when the temperature of the oven compartment 10 does not reach the setup temperature of the kneading mode.

In the above embodiment, only the lower oven heater and the lower door heater are heated in the leavening mode, but the upper oven heater and the lower door heater may be heated with a predetermined duties to an extent that the kneaded ingredients are not burned.

In the above embodiment, the heating power of the upper oven heater and the upper door heater are increased in the baking process, and the lower oven heater and the lower door heater are relatively decreased, but different embodiments can be applied.

As described above, according to the present invention, the oven temperature reaches processing temperature by respectively adjusting the duties of the plurality of heaters. Accordingly, an optimum product is made through these operations.

As described above, according to the present invention, a bread maker and a control method thereof is provided to accurately control temperature and obtain an optimum product by maintaining temperature of the oven compartment at a processing temperature by adjusting heating powers of a plurality of heaters.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A bread maker performing a plurality of bread making processes, in an oven compartment, which accommodates ingredients to make bread, at respective processing temperatures during predetermined processing times, comprising:
a plurality of heaters heating the ingredients, to make the bread, in different directions from each other;
a heater driving part supplying a driving power to each heater and to control a heating power of each heater;
a temperature sensor detecting a temperature of the oven compartment;
a process condition storing part storing process condition data including the processing times and the processing temperatures of the plurality of bread making processes; and
a controller controlling the heater driving part to maintain temperature of the oven compartment at the processing temperature by controlling the heating power of each heater according to the temperature detected by the temperature sensor and the process condition data of the process condition storing part.

2. The bread maker according to claim 1, wherein the plurality of heaters comprises:
an upper oven heater and an upper door heater in upper parts of an inside wall of the oven compartment;
a lower oven heater and a lower door heater in lower parts of the inside walls of the oven compartment; and
a door to open and close an front opening of the oven compartment, wherein
the upper oven heater and the upper door heater heat front and back areas of the upper the of the oven compartment, and
the lower oven heater and the lower door heater heat front and back areas of the lower parts of the oven compartment.

3. The bread maker according to claim 2, wherein the controller controls the heater driving part to turn the upper oven heater, the upper door heater, the lower oven heater, and the lower door heater off during a kneading process.

4. The bread maker according to claim 2, wherein the controller controls the heater driving part to decrease the heating powers of the upper oven heater and the upper door heater and to relatively increase the heating powers of the lower oven heater and the lower door heater according to the heating powers of the upper oven heater and the upper door heater during a leavening process.

5. The bread maker according to claim 4, wherein the controller controls the heater driving part so that the heating powers of the upper oven heater and the upper door heater are turned off and duties of the lower oven heater and the lower door heater are about 10 through 40% during the leavening process.

6. The bread maker according to claim 2, wherein the controller controls the heater driving part to increase the heating powers of the upper oven heater and the upper door heater and to relatively decrease the heating powers of the lower oven heater and the lower door heater according to the heating powers of the upper oven heater and the upper door heater during a baking process.

7. The bread maker according to claim 6, wherein the controller controls the heater driving part so that duties of the heating powers of the upper oven heater and the upper door heater are about 80 through 100% and duties of the lower oven heater and the lower door heater are about 70 through 90% during the baking process.

8. A method to control a bread maker, in which a plurality of heaters heat ingredients to make bread from various directions, performing a plurality of bread making processes in different processing temperatures from each other during predetermined processing times;
storing process condition data of the bread;
sensing temperature of an oven compartment;
controlling a heater driving part to maintain temperature of the oven compartment.

9. The method according to claim 8, further comprising providing a mixing bag having a bar code registered with data of processing times and processing temperatures for use with the mixing bag.

10. A bread maker, including an oven compartment, which accommodates ingredients to make bread using various bread making processes, comprising:
a plurality of heaters, requiring variable supplied driving powers, to have variable heating powers, multi-directionally heating the ingredients;
a heater driving part supplying the driving power to control the heating powers;
a temperature sensor detecting temperature of the oven compartment;
process condition storage storing process condition data of the bread making processes; and
a controller controlling the heater driving part to maintain a predetermined temperature in the oven compartment according to the sensed temperature of the oven compartment and the stored process condition data.

11. The bread maker according to claim 10, wherein the plurality of heaters comprise:
an upper oven heater and an upper door heater in upper parts of an inside wall of the oven compartment;
a lower oven heater and a lower door heater in lower parts of the inside walls of the oven compartment; and
a door to open and close an front opening of the oven compartment, wherein
the upper oven heater and the upper door heater heat front and back areas of an upper portion of the oven compartment, and
the lower oven heater and the lower door heater heat front and back areas of a lower part of the oven compartment.

12. The bread maker according to claim 11, wherein the controller controls the heater driving part to turn the upper oven heater, the upper door heater, the lower oven heater, and the lower door heater off during a kneading process.

13. The bread maker according to claim 11, wherein the controller controls the heater driving part to decrease the heating powers of the upper oven heater and the upper door heater and to relatively increase the heating powers of the lower oven heater and the lower door heater according to the heating powers of the upper oven heater and the upper door heater during a leavening process.

14. The bread maker according to claim 13, wherein the controller controls the heater driving part so that the heating powers of the upper oven heater and the upper door heater are turned off and duties of the lower oven heater and the lower door heater are 10 through 40% during the leavening process.

15. The bread maker according to claim 10, wherein the controller controls the heater driving part to increase the heating powers of the upper oven heater and the upper door heater and to relatively decrease the heating powers of the lower oven heater and the lower door heater according to the heating powers of the upper oven heater and the upper door heater during a baking process.

16. The bread maker according to claim 15, wherein the controller controls the heater driving part so that duties of the heating powers of the upper oven heater and the upper door heater are 80 through 100% and duties of the lower oven heater and the lower door heater are 70 through 90% during the baking process.

17. A bread maker, including an oven, which accommodates ingredients to make bread using various bread making processes involving various kneading processes, comprising:
a plurality of heaters, requiring variable supplied driving powers, to have variable heating powers, multi-directionally heating the ingredients;
a heater driving part supplying the driving power to control the heating powers;
a temperature sensor detecting temperature of the oven compartment;
process condition storage storing process condition data of the bread making processes; and
a controller controlling the heater driving part to maintain a predetermined temperature in the oven compartment according to the sensed temperature of the oven compartment and the stored process condition data, wherein the controller effectively turns the heaters off and on during the kneading processes thereby maintaining at least a setup temperature of the kneading processes.

18. A bread maker, including an oven having upper and lower portions, and a door having upper and lower portions, which accommodates ingredients to make bread using various bread making processes involving various leavening processes, comprising:
a plurality of heaters, respectively, in the lower portion of the oven, the lower portion of the door, the upper portion of the oven, and the upper portion of the door, requiring variable supplied driving powers, to have variable heating powers, heating the ingredients;
a heater driving part supplying the driving power to control the heating powers;
a temperature sensor detecting temperature of the oven compartment;
process condition storage storing process condition data of the bread making processes; and
a controller controlling the heater driving part to maintain a predetermined temperature in the oven according to the sensed temperature of the oven compartment and the stored process condition data, wherein during the leavening processes, the controller effectively controls the heater in the lower portion of the oven and the heater in the lower portion of the door, thereby providing heat.

19. The bread maker according to claim 18, wherein the controller effectively controls the heater in the upper portion of the oven and the upper portion of the door to provide heat to the extent that the ingredients do not burn.
